(19) United States
(12) Patent Application Publication
(10) Pub. No.: US 2022/0343139 A1
(43) Pub. Date: Oct. 27, 2022

(54) METHODS AND SYSTEMS FOR TRAINING A NEURAL NETWORK MODEL FOR MIXED DOMAIN AND MULTI-DOMAIN TASKS

(71) Applicants: Peyman PASSBAN, Montreal (CA); Amirmehdi SHARIFZAD, Richmond Hill (CA); Mehdi REZAGHOLIZADEH, Montreal (CA); Khalil BIBI, Montreal (CA)

(72) Inventors: Peyman PASSBAN, Montreal (CA); Amirmehdi SHARIFZAD, Richmond Hill (CA); Mehdi REZAGHOLIZADEH, Montreal (CA); Khalil BIBI, Montreal (CA)

(21) Appl. No.: 17/231,940

(22) Filed: Apr. 15, 2021

(51) Int. Cl. G06N 3/04; G06N 3/08

(52) U.S. Cl. CPC G06N 3/0454; G06N 3/08

(57) ABSTRACT

Methods and systems for training a neural network model using domain mixing and multi-teacher knowledge distillation are described. Tokens, including a unique token, are inputted to an encoder of the neural network model. A unique embedding vector encoded from the unique token is inputted to an adaptor network to generate domain probabilities. A domain mixing embedding vector, determined from the unique embedding vector, is inputted to a predictor of the neural network model, to generate a predicted output. A final loss is computed using a domain mixing loss computed from the domain probabilities and a ground-truth domain of the data sample, and using an output prediction loss computed from the predicted output and a ground-truth label of the data sample. Parameters of the neural network model and adaptor network are updated using the final loss.

### FIELD

The present disclosure relates to methods and systems to train neural network models for multi-domain tasks, including methods and systems for training a neural network model using knowledge distillation to perform a multi-domain task.

### BACKGROUND

Machine learning is commonly used in natural language processing (NLP) and computer vision (CV) applications. Deep learning is one of the most successful and widely deployed machine learning algorithms used in NLP and CV applications. In deep learning, artificial neural networks (“neural networks”) include an input layer, multiple hidden layers, and an output layer of non-linear parametric functions (commonly referred to as neurons). An artificial neural network (commonly referred to as a “neural network model” or simply “model”) is trained using a learning algorithm to optimize values of the parameters (e.g. the weights and bias) of a the neural network model, such that predictions generated by the trained neural network model (also referred to simply as the trained model) achieves a desired level of performance (e.g., desired level of prediction accuracy). Often, improvements in performance are associated with increases in complexity (e.g., increase in the number of layers and/or size of the layers) of the neural network model. The result is that a trained neural network model with high accuracy may not be practical to execute (e.g., may not be practical for deployment in consumer computing devices or other edge computing devices having limited computing resources, such as processing cores, processing power, cache, and/or memory).

Knowledge distillation (KD) is technique for training a smaller neural network model for a task (commonly referred to as the “student”, or “student model”) using outputs extracted from a larger neural network model for the same task (commonly referred to as the “teacher”, or “teacher model”) to transfer the knowledge of the teacher model to the student model. The teacher model typically is a larger and deeper neural network model (e.g. a neural network model that includes a larger number of parameters and a greater number of layers than the student model) that achieves high accuracy (or other performance metric), but is not practical for deployment to computing devices with limited computing resources. The student model typically is smaller and is less deep than the teacher model (e.g., the student model has fewer parameters, fewer layers, fewer dimensions, etc., than the teacher model) and is suitable for deployment to computing devices with limited computing resources (e.g., the student model executes faster and/or requires fewer computing resources for execution). In KD, the student model is trained using data samples obtained from a training dataset, and also using outputs (generated from the same data samples) extracted from the teacher model. The outputs extracted from the teacher model are typically the pseudo-probabilistic values (commonly referred to as logits) outputted from the penultimate neural network layer of the teacher model.

A neural network model is typically trained to optimize the values of its parameters using data samples obtained from a training dataset from a given domain, to perform a given task. A domain may define a particular shared context of the data samples in the training dataset. The result is that the trained neural network model may have good performance (e.g., generate predictions with high accuracy) for data samples from one domain (i.e., the domain represented by the training dataset) but may have lower performance (e.g., generate predictions with lower accuracy) for data samples from a different domain. Multi-domain training is a technique that can be used to improve the performance of a trained neural network model, in which the trained neural network model performs the given task accurately and (almost) equally for data samples from all domains. However, it remains a challenge to efficiently and effectively train a neural network model to perform a given task at inference on data samples obtained from a multi-domain dataset.

It would be useful to provide training methods and systems that enable a trained neural network to improve performance of the trained task for data samples across different domains.

### SUMMARY

In various examples, the present disclosure describes methods and systems for training a neural network model using domain mixing (e.g., concatenating/combining different datasets covering different domains, to inform the neural network model about multiple domains). Domain mixing is a technique that enables the neural network model to be trained to perform a multi-domain task (i.e., to perform a task accurately, with the same or nearly the same accuracy across multiple domains). The neural network model may be trained to perform a generative task (e.g., the neural network model may be a transformer-based model, including an encoder-decoder), or a discriminative task (e.g., the neural network model may include an encoder with a classifier), for example. Domain-related information is encoded by the encoder (e.g., encoded in a unique embedding vector), and provided to an adaptor network during training of the neural network model. Domain probabilities outputted from the adaptor network are used in loss computation during training of the neural network model. Domain-related information is also provided as input to the decoder or classifier in the neural network model.

In some examples, the neural network model may be trained using multi-teacher knowledge distillation. The contributions from different teacher models may be dynamically weighted using outputs from the adaptor network.

The examples described herein may be applicable to multi-domain training (i.e., training a neural network model to perform a task with equal or near equal accuracy on data samples from multiple domains), multi-task training (i.e., training a neural network model to perform multiple tasks with equal or near equal accuracy), multi-source training (i.e., training a neural network model to perform a task with equal or near equal accuracy on data samples from multiple sources), or combinations thereof.

The examples described herein may be applicable to a variety of machine learning applications, including applications in NLP (e.g., machine translation applications, conversation bot applications, etc.) or computer vision applications (e.g., object detection, object classification, image classification, semantic segmentation etc.), among other possibilities.

In some example aspects, the present disclosure describes a method for training a neural network model having an encoder and a predictor. The method includes: inputting a set of tokens from a data sample to the encoder of the neural network model, the set of tokens including a unique token and other tokens, the encoder generating a set of embedding vectors including a unique embedding vector encoded from the unique token and other embedding vectors encoded from the other tokens; inputting the unique embedding vector to an adaptor network to generate a set of domain probabilities representing a likelihood that the unique embedding vector belongs to each domain of a set of domains; computing a domain mixing loss using the set of domain probabilities and a ground-truth domain of the data sample; inputting at least a domain mixing embedding vector, determined from the unique embedding vector, to the predictor of the neural network model, to generate a predicted output; computing an output prediction loss using the predicted output and a ground-truth label of the data sample; computing a final loss using the domain mixing loss and the output prediction loss; updating values of parameters of the neural network model and the adaptor network, using the computed final loss; and storing the updated values of parameters of the neural network model as learned values of the parameters of the neural network model.

In the preceding example aspects of the method, the steps of inputting the set of tokens, inputting the unique embedding vector, computing the domain mixing loss, inputting at least the domain mixing embedding vector, computing the output prediction loss, computing the final loss and updating the values of the parameters may be repeated for each data sample in a batch of training data samples obtained from a training dataset.

In any of the preceding example aspects of the method, the predictor may be a decoder, and the other embedding vectors may be also inputted to the decoder to generate the predicted output.

In any of the preceding example aspects of the method, the predictor may be a classifier, and only the domain mixing embedding vector may be inputted to the classifier to generate the predicted output.

In any of the preceding example aspects of the method, the domain mixing embedding vector may be the unique embedding vector.

In any of the preceding example aspects of the method, the method may include computing the domain mixing embedding vector by: extracting, from the adaptor network, a domain embedding vector representing each respective domain in the set of domains; and computing the domain mixing embedding vector as a weighted sum of the domain embedding vectors, each domain embedding vector being weighted by the respective domain probability for the respective domain.

In any of the preceding example aspects of the method, the method may include: inputting the set of tokens to each of a plurality of teacher models, to generate a respective set of logits from each teacher model, each teacher model being pre-trained in a respective single domain of the set of domains; and computing at least one of a distillation loss or a contrastive loss using at least one set of logits from one teacher model and a set of logits generated by the predictor, and the at least one of the distillation loss or the contrastive loss may be further included in computing the final loss.

In any of the preceding example aspects of the method, the distillation loss may be computed using the set of logits generated by the predictor and the set of logits generated by an in-domain teacher model, the in-domain teacher model being the teacher model that is pre-trained in the domain corresponding to the ground-truth domain of the data sample.

In any of the preceding example aspects of the method, the distillation loss may be computed using the set of logits generated by the predictor and a weighted aggregation of the sets of logits from the plurality of teacher models, each set of logit generated by a respective teacher model being weighted by the domain probability corresponding to the domain of the respective teacher model.

In any of the preceding example aspects of the method, both the distillation loss and the contrastive loss may be computed, and both the distillation loss and the contrastive loss may be further included in computing the final loss.

In some example aspects, the present disclosure describes a computing system for training a neural network model having an encoder and a predictor. The computing system includes a processing unit and a memory storing instructions which, when executed by the processing unit, cause the computing system to: input a set of tokens from a data sample to the encoder of the neural network model, the set of tokens including a unique token and other tokens, the encoder generating a set of embedding vectors including a unique embedding vector encoded from the unique token and other embedding vectors encoded from the other tokens; input the unique embedding vector to an adaptor network to generate a set of domain probabilities representing a likelihood that the unique embedding vector belongs to each domain of a set of domains; compute a domain mixing loss using the set of domain probabilities and a ground-truth domain of the data sample; input at least a domain mixing embedding vector, determined from the unique embedding vector, to the predictor of the neural network model, to generate a predicted output; compute an output prediction loss using the predicted output and a ground-truth label of the data sample; compute a final loss using the domain mixing loss and the output prediction loss; update values of parameters of the neural network model and the adaptor network, using the computed final loss; and store the updated values of the parameters of the neural network model as learned values of the parameters of the neural network model.

In the preceding example aspects of the computing system, the steps of inputting the set of tokens, inputting the unique embedding vector, computing the domain mixing loss, inputting at least the domain mixing embedding vector, computing the output prediction loss, computing the final loss and updating the values of the parameters may be repeated for each data sample in a batch of training data samples obtained from a training dataset.

In any of the preceding example aspects of the computing system, the predictor may be a decoder, and the other embedding vectors may be also inputted to the decoder to generate the predicted output.

In any of the preceding example of the computing system, the predictor may be a classifier, and only the domain mixing embedding vector may be inputted to the classifier to generate the predicted output.

In any of the preceding example aspects of the computing system, the domain mixing embedding vector may be the unique embedding vector.

In any of the preceding example aspects of the computing system, the instructions may further cause the computing system to compute the domain mixing embedding vector by: extracting, from the adaptor network, a domain embedding vector representing each respective domain in the set of domains; and computing the domain mixing embedding vector as a weighted sum of the domain embedding vectors, each domain embedding vector being weighted by the respective domain probability for the respective domain.

In any of the preceding example aspects of the computing system, the instructions may further cause the computing system to: input the set of tokens to each of a plurality of teacher models, to generate a respective set of logits from each teacher model, each teacher model being pre-trained in a respective single domain of the set of domains; and compute at least one of a distillation loss or a contrastive loss using at least one set of logits from one teacher model and a set of logits generated by the predictor; the at least one of the distillation loss or the contrastive loss being included in computing the final loss.

In any of the preceding example aspects of the computing system, the distillation loss may be computed using the set of logits generated by the predictor and the set of logits generated by an in-domain teacher model, the in-domain teacher model being the teacher model that is pre-trained in the domain corresponding to the ground-truth domain of the data sample.

In any of the preceding examples, the distillation loss may be computed using the set of logits generated by the predictor and a weighted aggregation of the sets of logits from the plurality of teacher models, each set of logit generated by a respective teacher model being weighted by the domain probability corresponding to the domain of the respective teacher model.

In any of the preceding example aspects of the computing system, both the distillation loss and the contrastive loss may be computed, and both the distillation loss and the contrastive loss may be further included in computing the final loss.

In any of the preceding example aspects of the computing system, the computing system may provide a cloud-based service for training the neural network model.

In some example aspects, the present disclosure describes a non-transitory computer readable medium having instructions encoded thereon. The instructions, when executed by a processing unit of a computing system, cause the computing system to: input a set of tokens from a data sample to an encoder of a neural network model, the set of tokens including a unique token and other tokens, the encoder generating a set of embedding vectors including a unique embedding vector encoded from the unique token and other embedding vectors encoded from the other tokens; input the unique embedding vector to an adaptor network to generate a set of domain probabilities representing a likelihood that the unique embedding vector belongs to each domain of a set of domains; compute a domain mixing loss using the set of domain probabilities and a ground-truth domain of the data sample; input at least a domain mixing embedding vector, determined from the unique embedding vector, to a predictor of the neural network model, to generate a predicted output; compute an output prediction loss using the predicted output and a ground-truth label of the data sample; compute a final loss using the domain mixing loss and the output prediction loss; update values of the parameters of the neural network model and the adaptor network, using the computed final loss; and store the updated values of the parameters of the neural network model as learned values of the parameters of the neural network model.

In some example aspects, the present disclosure describes a method for training a neural network model having an encoder and a predictor. The method includes: inputting an input data sample to the encoder of the neural network model, the encoder generating an embedding vector encoded from the input data sample; inputting the embedding vector to an adaptor network to generate a set of domain probabilities representing a likelihood that the embedding vector belongs to each domain of a set of domains; computing a domain mixing loss using the set of domain probabilities and a ground-truth domain of the data sample; inputting at least a domain mixing embedding vector, determined from the unique embedding vector, to the predictor of the neural network model, to generate a predicted output; computing an output prediction loss using the predicted output and a ground-truth label of the data sample; computing a final loss using the domain mixing loss and the output prediction loss; updating values of parameters of the neural network model and the adaptor network, using the computed final loss; and storing the updated values of parameters of the neural network model as learned values of the parameters of the neural network model.

In any of the preceding examples, the computer readable medium may further include instructions to cause the computing system to perform any of the example aspects of the methods described above.

### BRIEF DESCRIPTION OF THE DRAWINGS

Reference will now be made, by way of example, to the accompanying drawings which show example embodiments of the present application, and in which:

FIGS. 1A and 1B are block diagrams of architectures for training a generative or discriminative neural network model, respectively, using an adaptor network, in accordance with examples of the present disclosure;

FIG. 2 is a flowchart illustrating an example method for training a neural network model using an adaptor network, in accordance with examples of the present disclosure;

FIG. 3 is a block diagram of an architecture for training a generative neural network model using an adaptor network to compute a domain tag, in accordance with an example of the present disclosure;

FIG. 4 is a flowchart illustrating an example method for training a neural network model using an adaptor network to compute a domain tag, in accordance with examples of the present disclosure;

FIGS. 5A-5C are block diagrams of architectures for training a generative or discriminative neural network model, using an adaptor network and multiple teacher models, in accordance with examples of the present disclosure;

FIG. 6 is a flowchart illustrating an example method for training a neural network model using an adaptor network and multiple teacher models, in accordance with examples of the present disclosure; and

FIG. 7 is a block diagram of a computing system in which examples of the present disclosure may be implemented.

Similar reference numerals may have been used in different figures to denote similar components.

### DESCRIPTION OF EXAMPLE EMBODIMENTS

In various examples, the present disclosure describes methods and systems for multi-domain training of a neural network model, including methods and systems that include the use of an adaptor network during training of the neural network model. The adaptor network receives an embedding vector that is an encoded representation of the input data to the neural network model and outputs domain probabilities representing the likelihood that the input data is from each domain of a plurality of possible domains. The domain probabilities are used in loss computation during training, and enable the neural network model to learn to encode domain-related information. In some examples, multi-teacher knowledge distillation (KD) is also used for training a neural network model for performing a task for data samples from multiple domains at inference. In the present disclosure, the term multi-domain training refers to training a neural network model to perform a task with equal or near equal accuracy on data samples from multiple domains (e.g., training a neural network model to perform a natural language processing task on text sampled from fiction novels as well as from scientific papers), multi-source training refers to training a neural network model to perform a task with equal or near equal accuracy on data samples from multiple sources (e.g., training a neural network model to perform an object detection task on images sampled from different image databases), and multi-task training refers to training a neural network model to perform multiple tasks with equal or near equal accuracy (e.g., training a neural network model to perform binary NLP classification between positive or negative sentiments, as well as between male or female authorship). Domain mixing is a technique that enables the neural network model to be trained to perform a multi-domain task (i.e., to perform a task accurately, with the same or nearly the same accuracy across multiple domains). Domain mixing may involve concatenating/combining different datasets covering different domains, to train the neural network model using data samples from different domains.

Although the present disclosure makes reference to multi-domain training and domain mixing, it should be understood that the examples disclosed herein may be readily adapted to multi-task training and multi-source training. Further, it should be understood that a neural network model may be trained based on a combination of multi-domain, multi-task and multi-source training (e.g., a neural network model may be trained to perform multiple tasks on data samples from multiple domains, with equal or nearly equal performance over different tasks and different domains).

To assist in understanding the present disclosure, some existing techniques for training neural network models are first discussed.

Consider a student model (terms associated with the student model are denoted using the subscript 5) that is trained using a training dataset belonging to a given domain (terms associated with the given domain are denoted using the subscript or superscript d). The training dataset (denoted as D_{d}) may be represented as

D_{d}={(x_{d}¹,y_{d}¹) . . . (x_{d}^{N},y_{d}^{N})}

where x_{d}ⁱ is the i-th data sample in the training dataset D_{d}, and y_{d}ⁱ is the ground-truth label associated with the i-th data sample.

A typical technique to train the student model to perform a multi-class classification task involves minimizing the negative log-likelihood (nll) of the data samples, as shown in the following equation:

[symbol]

nll(θs,d)=−Σ₍ₓ_{_{d}}_{i,y}_{_{d}}_{i)∈D}_{_{d}}Σ_{ν=1}|V|1(y_{d}ⁱ=ν)log p(y_{d}ⁱ=ν|x_{d}ⁱ;θ_{S})

where [symbol] ₙₗₗ denotes the negative log-likelihood loss, 1(.) is an indicator function, θ_{S} is the set of parameters of the student model, ν is the predicted class, and |V| is the number of classes. It should be noted that this loss may be adapted for various tasks, such as machine translation tasks (e.g., ν is the predicted translation in the target language, and |V| is the size of the vocabulary in the target language). In this training technique, the student model does not receive any feedback for misclassified data samples, because the indicator function 1(.) returns a value of zero for misclassified data samples.

KD aims to improve training of the student model by introducing a loss term that includes output extracted from a teacher model (terms associated with the teacher model are denoted using the subscript T) that has been pre-trained to have good performance in the given domain d. In KD training, an additional distillation loss is defined as follows:

[symbol]

_{KD}(θ_{T}^{d},θ_{S})=−Σ₍ₓ_{_{d}}_{i,y}_{_{d}}_{i)∈D}_{_{d}}Σ_{ν=1}|V|q(y_{d}ⁱ=ν|x_{d}ⁱ;θ_{d}^{T})×log p(y_{d}ⁱ=ν|x_{d}ⁱ;θ_{S})

where [symbol] _{KD} denotes the distillation loss, and the output extracted from the teacher model is represented by the term q(y=ν|x;θ_{T}^{d}). In the distillation loss, the student model's predictions are penalized with its own loss as well as the outputs (representing the pseudo probabilities of generated predictions, or the logits) from the teacher model. The first component of the distillation loss (i.e., the q term) is usually referred to as the soft loss and the remainder of the distillation loss is referred to as the hard loss.

In KD training, the negative log-likelihood loss and the distillation loss are combined to arrive at the final loss, which has at least two loss terms, as follows:

[symbol]

=α [symbol] ₙₗₗ+(1−α)L_{KD}

where α (which has a value between 0 and 1) is a hyperparameter that is selected to control the balance between the two loss terms.

KD using multiple teacher models can be used to help train a student model for domain adaptation. Given a set of domains, there are multiple single-domain teacher models, such that there is a single-domain teacher model with respective parameters θ_{T}ⁱ trained on a respective training dataset Dᵢ that is specific to the domain i. The distillation loss can be computed with respect to each of these single-domain teacher models and combined to train a multi-domain student model with parameters θ_{S} by minimizing the following total loss:

[symbol]

=Σα [symbol] ₙₗₗ(θ_{S},d)+(1−α) [symbol] _{KD}(θ_{T}^{d},θ_{S})

Another technique uses domain mixing to train a neural network model to perform a multi-domain task. For example, Britz et al. (“Effective domain mixing for neural machine translation.” Proceedings of the Second Conference on Machine Translation. 2017) describe a technique for training a translation model on multi-domain data to improve test-time performance in each constituent domain. An adaptor network is introduced on top of the source encoder that accepts a single vector encoding of the source tokens as input. The adaptor network then outputs a prediction the domain of the source tokens by minimizing the negative cross entropy loss, expressed as:

[symbol]

_{disc}=−log p(d|H)

where H denotes the vector encoding of the source tokens.

This technique has not been shown to be effective for training a Transformer-based neural network model. Further, this technique does not directly provide domain information to a decoder of a transformer-based neural network model.

Another training technique is referred to as contrastive learning. Contrastive learning is a way of learning distinctiveness, and has been mainly used for self-supervised learning. The concept behind contrastive learning is that data samples from the same class (referred to as positive samples) are pulled closer together in an embedding space (i.e., the latent space defined by all possible embeddings generated by the encoder of a transformer-based neural network model), and data samples from different classes (referred to negative samples) are pushed apart in the embedding space.

Consider a mini batch of N data samples, which is augmented (e.g., by applying image augmentation or other data augmentation techniques to each data sample) to produce a batch of 2N data samples containing both positive and negative data samples. The loss function between two positive samples is defined as follows:

$${l}_{i , j} = - log \frac{exp ( \frac{sim ( {z}_{i} , {z}_{j} )}{τ} )}{{\sum }_{k = 1}^{2 N} 1 \{ k \neq j \} exp ( \frac{sim ( {z}_{i} , {z}_{k} )}{τ} )}$$

where the function sim( ) computes the cosine similarity between the two positive samples zᵢ, zⱼ, and τ is the temperature parameter. Minimization of this loss requires the cosine similarity between the positive samples zᵢ, zⱼ to be high. Conceptually, this means that the positive samples are pulled closer together in the embedding space and other samples (i.e., negative samples) are pushed apart. As will be discussed further below, some examples of the present disclosure adapt the concept of contrastive learning for use in multi-teacher KD.

In various examples, the present disclosure describes methods and systems for multi-domain, multi-task and/or multi-source training of a neural network model. Examples of the present disclosure may be useful for applications in natural language processing (NLP) and computer vision, among other possibilities. For example, for NLP applications, methods and systems described herein may be useful for training a neural network model to perform multi-domain or multi-source translation tasks (e.g., translation from multiple source languages and/or translation of language in multiple contexts), multi-domain classification tasks (e.g., sentiment analysis dealing with multiple contexts, such as reviews of different product categories), or multi-domain conversation tasks (e.g., a chat bot that supports conversation on multiple different topics), among other possibilities. For computer vision applications, methods and systems described herein may be useful for multi-domain or multi-source object detection tasks (e.g., object detection in different types of image backgrounds), among other possibilities.

The present disclosure describes example methods and systems for training a neural network model to perform a generative task (e.g., using a transformer-based model, comprising an encoder and a decoder). The present disclosure also describes example methods and systems for training a neural network model to perform a discriminative task (e.g., using a model comprising an encoder and a classifier). In general the neural network models described in various examples herein include an encoder that encodes the input data into one or more embedding vectors that is (are) latent representation(s) of the input data in an embedding space, and a predictor (e.g., decoder or classifier) that processes the embedding vector(s) to generate a predicted output (e.g., a predicted set of translated tokens in the target language, or a predicted class). The encoder and predictor (e.g., decoder or classifier) are part of the same network (e.g., corresponding to certain layers of the same network). However, in some embodiments the encoder and predictor (e.g., decoder or classifier) may be separate networks that together form the neural network model. The disclosed methods and systems may be applicable to any suitable neural network architecture, and may be adapted to any generative or discriminative multi-domain task.

The disclosed methods and systems enable the neural network model to learn from multiple domains, without requiring access to prior domain information, and enables the neural network model to adapt to new domains.

In some examples, the encoder is trained such that a unique token is encoded into a unique embedding vector that encodes domain level information, and the unique embedding vector can be included as input to the predictor (e.g., decoder or classifier), to enable the predictor to receive domain-related information as input. This technique may be referred to as dynamic domain mixing (DDM).

In some examples, a high level tag (e.g., a domain tag, a task tag or a source tag) is computed using information across multiple domains, to encode domain-related information (e.g., information representing likelihood of that data sample being from each of the multiple domains). The high level tag may then be included as input to the predictor (e.g., decoder). This technique may be considered a variation of DDM described above.

In some examples, multi-teacher KD may be used to support multi-domain training, together with DDM. Some examples include adjusting the KD contributions from different teacher models, based on output from an adaptor network.

It should be understood that, although examples are described in the context of multi-domain training, the disclosed methods and systems may be adapted for multi-task training and/or multi-source training. For simplicity, it should be understood that references to multi-domain training or domain mixing is not strictly limited to multiple domains, and is also intended to include multi-task and multi-source training.

Example methods and systems for training a neural network model for a generative task are described in the context of neural machine translation (NMT) as an example of a generative task. Example methods and systems for training a neural network model for a discriminative task are described in the context of sentiment analysis (SA) as an example of a discriminative task. It should be understood that these examples are not intended to be limiting, and the present disclosure may be applicable to any generative or discriminative task.

NMT is a machine learning task in which the neural network model has been trained to process input text in a source language (i.e. text in a source language input to the trained neural network model) and generate and output predicted text (that is a translation of the input text) in a target language. An example of a neural network model that is commonly used for NMT tasks is a transformer-based neural network model, which includes an encoder (which encodes the tokenized input text into a set of embedding vectors in the latent embedding space) and a decoder (which decodes the embedding vectors into a corresponding set of tokens in the target language).

In the context of NMT, multi-domain training may involve training the neural network model to translate from the source language to the target language in multiple technical fields (e.g., where different technical fields may have a different respective set of technical terms and/or where the same term may have different meaning depending on the technical field). Training may be performed using a training dataset, denoted as [symbol] , which contains text (e.g., sentences) in the source language (denoted as X) and the respective translation in the target language (denoted as [symbol] ). Thus, each data sample comprises an (x, y) pair, where x is the text in the source language and y is the corresponding translation in the target language.

SA is another machine learning task, in which the neural network model has been trained to process an input text and generate and output a predicted sentiment class label based on the sentiment contained in the text. For example, a common application of SA is to classify textual reviews of a product into positive reviews (i.e., a positive class) and negative reviews (i.e., a negative class). A neural network model that is commonly used for SA includes an encoder (which encodes the tokenized input text, including a unique token, into a set of embedding vectors) and a classifier (which processes the embedding vector corresponding to the unique token to predict the sentiment class of the text).

For training a neural network model to perform a SA task, the training dataset [symbol] may contains text (e.g., textual reviews) (denoted as x) and the corresponding sentiment class label (denoted as [symbol] ). Thus, each data sample comprises an (x, y) pair, where x is the text and y is the corresponding sentiment class label.

For both NMT and SA (or any generative or discriminative task in general), a multi-domain training dataset may be defined as:

[symbol]

={dₖ}_{k=1, . . . ,K}

where dₖ denotes a subset of data samples belonging to a single-domain (denoted as k).

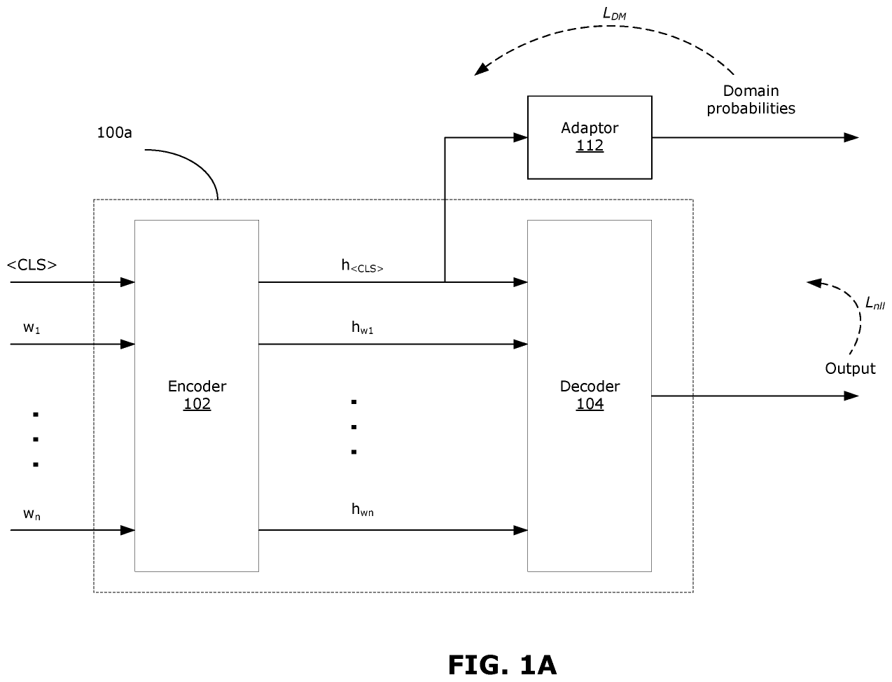

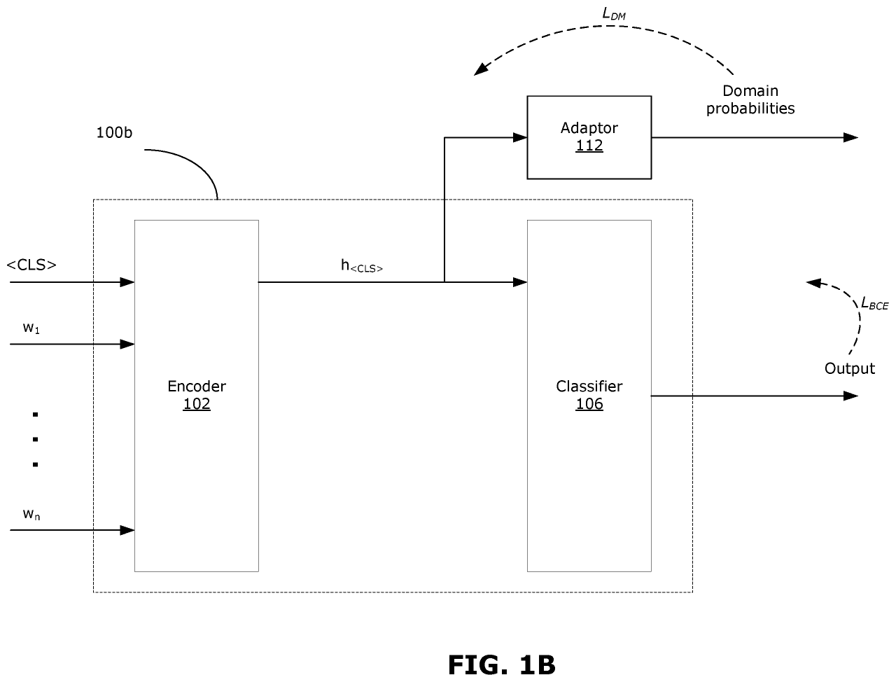

FIG. 1A is a block diagram of an example architecture for training a neural network model 100a to perform a generative task. FIG. 1B is a block diagram of an example architecture for training a neural network model 100b to perform a discriminative task. In both FIGS. 1A and 1B, an adaptor network is used during training to enable encoding of domain-related information. FIG. 1A will be described first.

In FIG. 1A, the neural network model 100a includes an encoder 102 and a decoder 104. The encoder 102 and the decoder 104 may each be a recurrent neural network (RNN), for example.

An input sentence x in the source language is sampled from the multi-domain training dataset [symbol] . Each input sentence x is labeled with a corresponding ground-truth translated sentence y in the target language. The ground-truth domain of the input sentence x is also known. The input sentence x is transformed into a set of n tokens (denoted as w₁, w₂, . . . , wₙ) using any suitable tokenization preprocessing algorithm. The set of tokens are provided as input to the encoder 102 which encodes each token into a respective embedding vector (denoted as h_{w1}, h_{w2}, . . . , h_{wn}).

In order to ensure that domain-related information is encoded, a unique token (e.g., the <CLS> token commonly used by a bidirectional encoder representations of transformers (BERT) encoder) is provided as input to the encoder 102 together with the set of tokens w₁, w₂, . . . , wₙ. For example, the unique token may be prepended to the input sentence x prior to tokenization. For simplicity, the <CLS> is described in the present examples, however any unique token may be used. The encoder 102 encodes the unique token into a unique corresponding embedding vector, denoted as h_{<CLS>}, and outputs the unique embedding vector h_{<CLS>} along with the embedding vectors h_{w1}, h_{w2}, . . . , h_{wn} corresponding to the set of tokens w₁, w₂, . . . , wₙ.

During training of the neural network model 100a, an adaptor network 112 is used. The adaptor network 112 is not used after the neural network model 100a has been trained (i.e., during inference). During training of the neural network model 100a, the unique embedding vector h_{<CLS>} is provided as input to the adaptor network 112. The adaptor network 112 may be any neural network (e.g., a convolutional neural network (CNN)) that processes the unique embedding vector h_{<CLS>} and generates and outputs domain probabilities representing the likelihood that the unique embedding vector h_{<CLS>} belongs to each domain (out of a defined set of domains). The domain probabilities are the softmax output of the adaptor network 112. The loss between the domain probabilities outputted by the adaptor network 112 and the ground-truth domain (denoted as [symbol] _{DM} and discussed further below) is computed and used for computing a final loss, which is in turn used to update the values of the parameters of the neural network model 100a and the adaptor network 112 in backpropagation (as indicated in all the figures using dashed curved arrows). Thus, using the unique embedding vector h_{<CLS>} as input to the adaptor network 112 results in the encoder 102 being trained to encode domain-related information when encoding the unique token into the unique embedding vector h_{<CLS>}.

The unique embedding vector h_{<CLS>} (which encodes domain-related information) is provided as input to the decoder 104, along with the set of embedding vectors h_{w1}, h_{w2}, . . . , h_{wn} encoded from the set of tokens w₁, w₂, . . . , wₙ. The decoder 104 processes unique embedding vector and the set of embedding vectors and generates and outputs a predicted output, which in this example is a set of translated tokens in the target language. In some examples, the unique embedding vector h_{<CLS>} is not necessarily included in the input to the decoder 104. A loss is computed between the predicted output and the ground-truth translation (denoted as [symbol] ₙₗₗ and discussed further below) and used for computing a final loss, which is in turn used to update the values of the parameters of the neural network model 100a and the adaptor network 112.

Reference is now made to FIG. 1B. The neural network model 100b in FIG. 1B is similar to the neural network model 100a in FIG. 1A, however the predictor is a classifier 106 instead of the decoder 104. The encoder 102 may, for example, be BERT.

Similar to the description of FIG. 1A above, the input to the encoder 102 is a tokenized input sentence x, sampled from the multi-domain training dataset [symbol] . Each input sentence x is labeled with a corresponding ground-truth class label y and the ground-truth domain of the input sentence x is known. The encoder 102 also receives a unique token (e.g., <CLS> token, although any other unique token may be used) together with the other tokens w₁, w₂, . . . , wₙ (from tokenization of the input sentence x). The encoder 102 generates the unique embedding vector h_{<CLS>} (corresponding to the unique token <CLS>) along with the embedding vectors h_{w1}, h_{w2}, . . . , h_{wn} (corresponding to the other tokens w₁, w₂, . . . , wₙ).

As in the example of FIG. 1A, the unique embedding vector h_{<CLS>} is processed by the adaptor network 112, and the computed loss [symbol] _{DM} is used during backpropagation to update the values of the parameters of the adapter network 112 and the encoder 102, so that the encoder 102 is trained to encode domain-related information when encoding the unique token into the unique embedding vector h_{<CLS>}.

The unique embedding vector h_{<CLS>} is provided as input to the classifier 106. The other embedding vectors h_{w1}, h_{w2}, . . . , h_{wn} may not be used by the classifier 106 and may be discarded. The classifier 106 processes the unique embedding vector h_{<CLS>} and outputs a predicted output, which in this example is a predicted class label (e.g., sentiment class label). A loss is computed between the predicted output (e.g. the predicted class label) and the ground-truth label (denoted as [symbol] _{BCE} and discussed further below) and used for computing a final loss, which is in turn used to update the values of the parameters of the neural network model 100b and the adaptor network 112 during backpropagation.

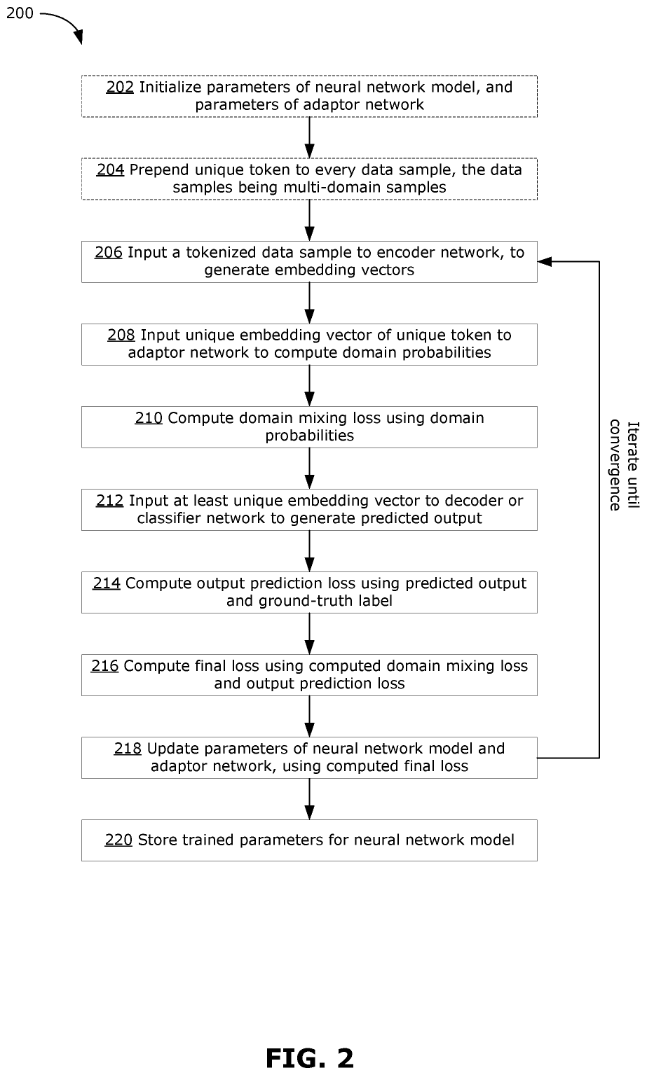

FIG. 2 is a flowchart of an example method 200 for training a neural network model, using an adaptor network. The method 200 may be used for training the neural network model 100a or the neural network model 100b, using the training architecture shown in FIG. 1A or FIG. 1B, respectively.

The training method 200 trains a neural network model (denoted M) having parameters (denoted θ_{M}), using a multi-domain training dataset (denoted [symbol] ). The neural network model may be the neural network model 100a (comprising an encoder 102 and a predictor that is a decoder 104) or the neural network model 100b (comprising a encoder 102 and a predictor that is a classifier 106). The training dataset [symbol] is a combination of several single-domain datasets [symbol] ᵢ, where each domain is denoted by the subscript i∈{1 . . . d}. Each single-domain dataset [symbol] ᵢ comprises data samples {(xᵢ¹, yᵢ¹), . . . , (xᵢ^{N}, yᵢ^{N})} where each data sample includes input data xᵢ^{N} and a ground-truth output yᵢ^{N} (e.g., ground-truth translation or ground-truth class label, depending on the generative or discriminative task). In some examples, instead of obtaining data samples (e.g. sampling) from a multi-domain training dataset, data samples may be obtained (e.g. sampled) from multiple single-domain training datasets; either way, training is performed using multi-domain samples, and it should be understood that both approaches are equivalent.

At 202, the values parameters θₘ of the neural network model 100a, 100b are initialized. The values parameters of the adaptor network 112 are also initialized. The values of the parameters of the adaptor network 112 are the values of the weights matrix W∈ [symbol] ^{{d×dim}}, where d is the number of different domains in the multi-domain training dataset and dim is the length of the embedding vectors generated by the encoder 102. It should be noted that the weights matrix W may also be expressed as a set of domain embedding vectors E∈ [symbol] ^{{d×dim}}, where each domain embedding vector eᵢ is a respective i-th row of the weights matrix W corresponding to the i-th domain, and E=[e₁|e₂| . . . |e_{d}]. The values parameters θ_{M} of the neural network model 100a, 100b may be initialized with random values. Similarly, the values of the parameters (i.e., the domain embedding vectors E) may also be initialized with random values. In some examples, initialization may not be required as part of the training method 200 (e.g., initialization may be performed prior to the start of training), and the step 202 may be omitted.

At 204, a unique token (e.g., <CLS> token) is prepended to each data sample, where the data samples are multi-domain samples (e.g., obtained (e.g. sampled) from a multi-domain training dataset, or obtained (e.g. sampled) from multiple single-domain training datasets). In some examples, a unique token may already be prepended to each data sample (e.g., the data samples in the training dataset may have already been preprocessed) and step 204 may be omitted.

At 206, input data of a data sample is tokenized (e.g., using any suitable tokenization algorithm) into a set of tokens and the set of tokens is inputted to the encoder 102, which processes the set of tokens and generates a set of embedding vectors. Data samples may be obtained (e.g. sampled) from the multi-domain training dataset in a batch-wise fashion, where a batch of data samples is randomly obtained (e.g. sampled) from Dᵢ, for i∈{1 . . . d}. For simplicity, the method 200 will be described with respect to how a single data sample is processed; however, it should be understood that training may be performed in a batch-wise fashion.

A data sample x is tokenized into a set of tokens including the unique token: {<CLS>, w₁, w₂, . . . , wₙ}. The encoder 102 processes the set of tokens and generates the set of embedding vectors {h_{<CLS>}, h_{w}_{₁}, . . . , h_{w}_{ₙ}}. Each embedding vector is a vector representation of the respective token in an embedding latent space (i.e., the latent space defined by all possible embedding vectors generated by the encoder 102).

At 208, the unique embedding vector h_{<CLS>} (i.e., the embedding vector encoded from the unique token <CLS>) is inputted to the adaptor network 112 to compute domain probabilities. In particular, the adaptor network 112 computes a set of domain probabilities, denoted as α₁, α₂, . . . , α_{d} where αᵢ represents the probability of that a given input x belongs to domain i and Σᵢ₌₁^{d}αᵢ=1. Mathematically, the domain probability αᵢ may be expressed as:

αᵢ=p(x∈ [symbol] ᵢ|h_{<CLS>})

The output of the adaptor network 112 may be represented as the set of domain probabilities P, where:

P=[α₁,α₂, . . . ,α_{d}]=softmax(mul(h_{<CLS>},E))

where mul is the multiplication function, and E is the set of domain embedding vectors (i.e., the rows of the weights matrix of the adaptor network 112).

At 210, the domain probabilities are used to compute a loss, referred to herein as the domain mixing loss and denoted [symbol] _{DM}. The domain mixing loss [symbol] _{DM} is computed based on log loss between the computed domain probabilities and the ground-truth domain for the data sample x. The domain mixing loss [symbol] _{DM} is defined in this example as:

$${ℒ}_{DM} = - \frac{1}{\vert 𝒟 \vert} {\sum }_{( x , y ) ε 𝒟} {\sum }_{i = 1}^{d} 1 \{ x ∈ {𝒟}_{i} \} log ( {α}_{i} ) \qquad ( 3 )$$

Including the domain mixing loss L_{DM} in the computation of the final loss, which is used to update the values of the parameters of the encoder 102, enables the encoder to encode domain-related information in the unique embedding vector h_{<CLS>} that encodes the unique token <CLS> (or other unique token).

At 212, the unique embedding vector h_{<CLS>} is also provided as input to the predictor (e.g., the decoder 104 or the classifier 106) of the neural network model 100a, 100b. If the predictor is the decoder 104, the unique embedding vector h_{<CLS>} is provided with the embedding vectors h_{w1}, . . . , h_{w}_{ₙ} encoded from the tokenized data sample, and the input to the decoder 104 may be represented as: DecoderIn=[h_{<CLS>}|h_{w}_{₁} . . . |h_{w}_{ₙ}]. The predicted output generated by the decoder 104 is a set of predicted translated tokens. If the predictor is the classifier 106, input to the classifier 106 may be just the unique embedding vector h_{<CLS>}. The predicted output generated by the classifier 106 is a predicted class label.

At 214, the output prediction loss is computed using the predicted output (from the decoder 104 or the classifier 106) and the ground-truth label.

If the predictor is the decoder 104, the output prediction loss may be computed based on negative log-likelihood (nil). The negative nll loss, denoted [symbol] ₙₗₗ, may be defined as follows:

$${ℒ}_{nll} ( 𝒟 ; {θ}_{M} ) = - {\sum }_{( x , y ) ∈ 𝒟} {\sum }_{t = 1}^{{T}_{y}} {\sum }_{k = 1}^{\vert v \vert} 1 \{ {y}_{t} = k \} log P ( {y}_{t} = k \vert {y}_{< t} , x ; {θ}_{M} )$$

where T_{y} is the length of the sentence in the target language, |ν| is the vocabulary size of the target language, and yₜ is the t-th translated token in the target language.

If the predictor is the classifier 106, the output prediction loss may be computed based on binary cross-entropy (BCE). The binary BCE loss, denoted [symbol] _{BCE}, may be defined as follows:

$${ℒ}_{BCE} ( {θ}_{M} ) = - \frac{1}{\vert 𝒟 \vert} {\sum }_{( x , y ) ∈ 𝒟} y \cdot log ( p ( y ) ) + ( 1 - y ) \cdot log ( 1 - p ( y ) )$$

For generality, the term output prediction loss (denoted [symbol] ₒᵤₜₚᵤₜ) may be used to refer to both the nll loss [symbol] ₙₗₗ computed from the predicted output of the decoder 104 as well as the BCE loss [symbol] _{BCE} computed from the predicted output of the classifier 106.

At 216, a final loss is computed using the domain mixing loss [symbol] _{DM} and the output prediction loss [symbol] ₒᵤₜₚᵤₜ The final loss, denoted [symbol] , may be defined as:

[symbol]

=α [symbol] ₒᵤₜₚᵤₜ+η [symbol] _{DM}

where α and η are coefficients that control the contribution of each loss. The coefficients α and η must sum to 1. The α and η coefficients may be selected (e.g., empirically or using grid-search technique) to tune the convergence rate, for example. As previously mentioned, the output prediction loss [symbol] ₒᵤₜₚᵤₜ is defined as the nll loss [symbol] ₙₗₗ if the predictor is the decoder 104 (i.e., the neural network model 100a is being trained to perform a generative task) and is defined as the BCE loss [symbol] _{BCE} if the predictor is the classifier 106 (i.e., the neural network model 100b is being trained to perform a discriminative task).

At 218, the values of the parameters θ_{M} of the neural network model 100a, 100b, as well as the values of the parameters (e.g., values in the weights matrix W) of the adaptor network 112 are updated using the computed final loss. For example, the gradients with respect to the final loss may be computed and the values of the parameters of the neural network model 100a, 100b and of the adaptor network 112 may be updated (i.e. adjusting) using a suitable optimization algorithm such as stochastic gradient descend (SGD).

All loss values are then reset and the method 200 may return to step 206 to process another data sample of the batch of data samples for another training iteration. The training iterations may repeat until a convergence condition is satisfied (e.g., a maximum number of iterations has been reached, or the loss values converge).

If the convergence condition is satisfied, then instead of returning to step 206 the method 200 proceeds to step 220 to store the updated values of the parameters θₘ of the neural network model 100a, 100b. The updated values of the parameters of the adaptor network 112 may also be stored, or may be discarded.

During inference, the appropriate neural network model 100a, 100b is executed using the corresponding stored values of the parameters θₘ. The adaptor network 112 may not be used during inference. It should be noted that the unique token continues to be included as input to the encoder 102 during inference, to enable encoding of domain-related information in the unique embedding vector h_{<CLS>}, which is provided as input to the predictor.

The multi-domain training described above enables domain-related information to be encoded and used for training both the encoder 102 and the predictor (e.g. the decoder 104 or the classifier 106). Although specific neural network models 100a, 100b have been discussed, the multi-domain training technique described above may be suitable for any neural network architecture, and in particular may be useful for training transformer-based neural network models.

In the above examples, domain-related information is inputted to the predictor (e.g., the decoder 104 or the classifier 106) using the unique embedding vector h_{<CLS>}. In some examples, domain-related information may be inputted to the predictor using a weighted sum of the domain embedding vectors extracted from the adaptor network 112. The weighted sum of domain embedding vectors may be referred to herein as a domain tag.

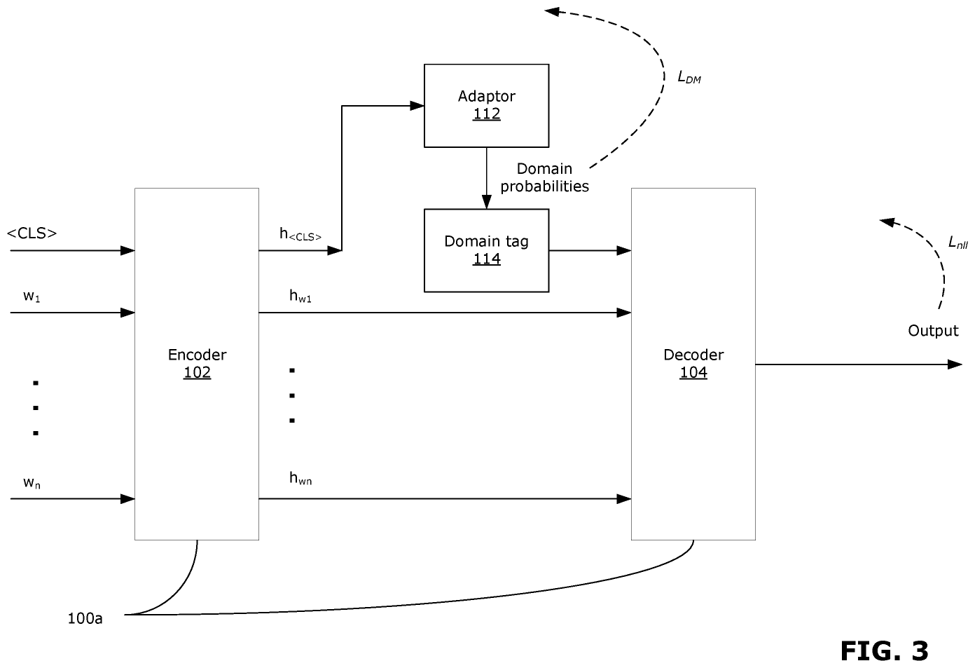

FIG. 3 is a block diagram illustrating an example architecture for training the neural network model 100a for a generative task using the domain tag as input to the predictor (e.g., the decoder 104) instead of the unique embedding vector h_{<CLS>}. The domain tag may not be used as input to the classifier 106.

FIG. 3 is similar to FIG. 1A, with the difference that the domain tag is computed using outputs from the adaptor network 112, and the computed domain tag provided as input to the decoder 104. Features that are shared with FIG. 1A have been labeled with the same reference numerals and need not be described again in detail.

In FIG. 3, a domain tag is computed (at domain tag computation block 114) using the domain probabilities αᵢ outputted by the adaptor network 112 and the domain embedding vectors eᵢ extracted from the weights matrix W of the adaptor network 112. The domain tag computation block 114 computes the domain tag as follows:

$$DomainTag = {\sum }_{j = 1}^{D} {α}_{j} \times {e}_{j}$$

where αⱼ is the domain probability as previously defined, and e₁ is the domain embedding vector extracted from the weights matrix W (i.e., row j of the weights matrix W).

For the neural network model 100a of FIG. 3, the domain tag is included with the embedding vectors h_{w}_{₁}, . . . , h_{w}_{ₙ} as input to the decoder 104 (i.e., input to the decoder 104 may be represented as:

DecoderIn=[DomainTag|h_{w1} . . . |h_{w}_{ₙ}].

Training of the neural network model 100a, using the example architecture for training the neural network model 100a shown in FIG. 3, is similar to the training described previously with respect to FIG. 2.

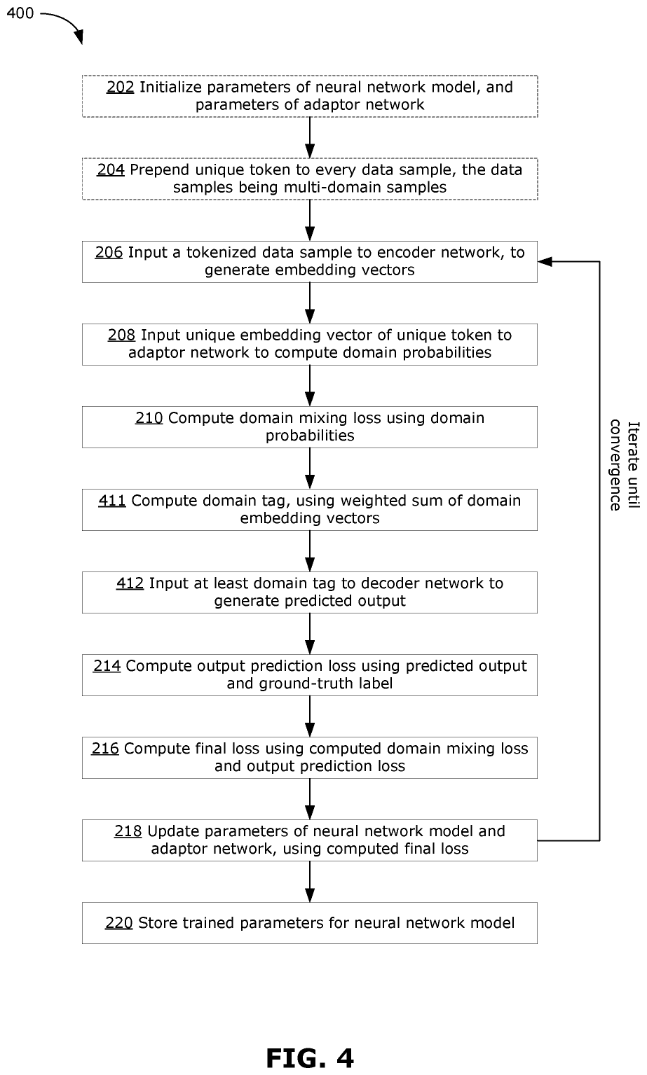

For completeness, FIG. 4 is a flowchart of an example method 400 for training a neural network model, where output from the adaptor network 112 is used to compute a domain tag. The method 400 may be used for training the neural network model 100a, using the training architecture of FIG. 3.

Various steps of the method 400 that are similar to the method 200 have been indicated with the same reference numerals, and need not be discussed again in detail.

The method 400 includes steps 202 to 210 as discussed above, and replaces step 212 with steps 411 and 412.

At 411, the domain tag is computed using the domain probabilities from the adaptor network 112 and the domain embedding vectors extracted from the adaptor network 112. As previously discussed, the domain tag is a weighted sum of the domain embedding vectors, where each domain embedding vector corresponding to a respective domain is weighted by the domain probability for the respective domain.

At 412, the computed domain tag is provided as input to the predictor (e.g., the decoder 104) of the neural network model 100a. If the predictor is the decoder 104, the computed domain tag is provided with the embedding vectors encoded from the tokenized data sample, and the input to the decoder 104 may be represented as: DecoderIn=[DomainTag|h_{w}_{₁} . . . |h_{w}_{ₙ}]. The predicted output generated by the decoder 104 is a set of predicted translated tokens.

The method 400 further includes steps 214 to 220 as discussed above.

During inference, the appropriate neural network model 100a is executed using the corresponding stored learned values of the parameters θ_{M}. Although the adaptor network 112 may not be used during inference, the learned values of the parameters of the adaptor network 112 may also be stored (e.g., may be stored as a set of domain embedding vectors e₁, e₂ . . . e_{d}) enable computation of the domain tag as input to the predictor during inference. For example, during inference, a similarity measure (denoted as zᵢ) can be computed between the unique embedding vector h_{<CLS>} and the set of domain embedding vectors eᵢ, by computing the dot product as follows:

zᵢ=dot(h_{<CLS>},e₁)

Then the domain probabilities αᵢ may be computed as follows:

$${α}_{i} = \frac{exp ( {z}_{i} )}{{\sum }_{j = 1}^{d} exp ( {z}_{i} )}$$

The domain tag may then be computed using the set of domain embedding vectors eᵢ and the domain probabilities αᵢ, as discussed above.

Providing the unique embedding vector h_{<CLS>} as input to the predictor (e.g., the decoder 104 or the classifier 106) or providing the domain tag as input to the predictor (e.g., if the predictor is the decoder 104) are both techniques to encode domain-related information as input to the predictor. In general, the unique embedding vector h_{<CLS>} and the domain tag may both be referred to as a domain mixing embedding vector (not to be confused with domain embedding vectors). The domain mixing embedding vector is determined from the unique embedding vector h_{<CLS>}, in that the domain mixing embedding vector is the unique embedding vector h_{<CLS>} itself, or is determined using values generated by the adaptor network 112 from the unique embedding vector h_{<CLS>}. In particular, the domain tag may be a way to directly access the domain embedding vectors learned by the adaptor network 112, and encode this domain-related information across multiple domains. Using the domain tag may enable the predictor to benefit from more explicit domain-related information, but with the tradeoff that more computations (and hence more processing power and/or memory resources) may be required.

In some examples, multi-teacher KD is also used for training the neural network model 100a, 100b. The use of multi-teacher KD, where there are different single-domain teachers that have been pre-trained on different domains, may further improve multi-domain performance of the trained neural network model 100a, 100b. Multi-teacher KD may be used in addition to the use of an adaptor network 112 as described above. To assist in understanding, some discussion of multi-teacher KD is provided.

In multi-teacher KD, there are multiple teacher models that have been each pre-trained, in a respective single domain, to perform the desired generative or discriminative task to a suitable level of performance (e.g., a suitable level of prediction accuracy). To train a multi-domain student model, the loss (referred to as distillation loss, and denoted as [symbol] _{distill}) between the logits generated by the student model (i.e., typically the penultimate neural network layer) and the logits generated by the teacher model is computed and is used to update the values of the parameters of the student model. The in-domain teacher model refers to the teacher model that has been pre-trained in the domain to which a given training data sample belongs, and different teacher models may be considered as the in-domain teacher model for different training data samples (since the ground-truth domains of all data samples in the training dataset are known, it is possible to identify the in-domain teacher model for each data sample). The pre-trained parameters of the teacher models may be denoted as {θ_{T}ⁱ}ᵢ₌₁^{d} for d different domains.

For a generative task, the distillation loss [symbol] _{distill} may be defined as:

$${ℒ}_{distill} = {ℒ}_{KD} ( {θ}_{T} , {θ}_{M} ) = - {\sum }_{i = 1}^{d} {\sum }_{( x . y ) ∈ 𝒟} {\sum }_{t = 1}^{{T}_{y}} {\sum }_{v = 1}^{\vert V \vert} q ( {y}_{t} = v \vert {y}_{< t} x ; {θ}_{T}^{i} ) log p ( {y}_{t} = v \vert {y}_{< t} x ; {θ}_{M} )$$

where [symbol] _{KD} denotes the distillation loss for training a generative neural network model, where the subscript T indicates the teacher model, the subscript M indicates the student model, and q(yₜ=ν|y_{<t}x;θ_{T}ⁱ) is the output distribution (i.e., the output logits) of the i-th teacher model (i.e., the teacher model that is pre-trained for the i-th domain.

For a discriminative task, the distillation loss [symbol] _{distill} may be defined as:

$${ℒ}_{distill} = {ℒ}_{KL} ( {θ}_{T} , {θ}_{M} ) = - \frac{1}{\vert 𝒟 \vert} {\sum }_{( x , y ) ε 𝒟} {\sum }_{i = 1}^{d} 1 \{ x ∈ {D}_{i} \} q ( x , {θ}_{T}^{i} ) log ( \frac{q ( x , {θ}_{T}^{i} )}{q ( x , {θ}_{M} )} )$$

where [symbol] _{KL} denotes the distillation loss for training a discriminative neural network model, where the subscript T indicates the teacher model, the subscript M indicates the student model, q(x, θ_{T}ⁱ) is the logits of the i-th teacher model for the input data sample x and g(x, θₘ) is the logits of the student model.

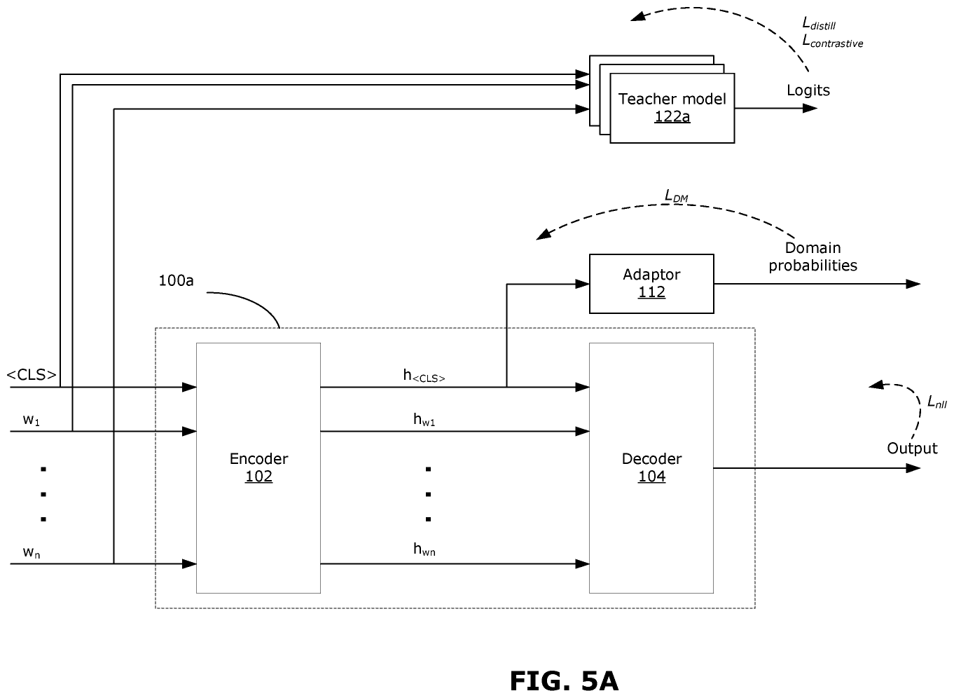

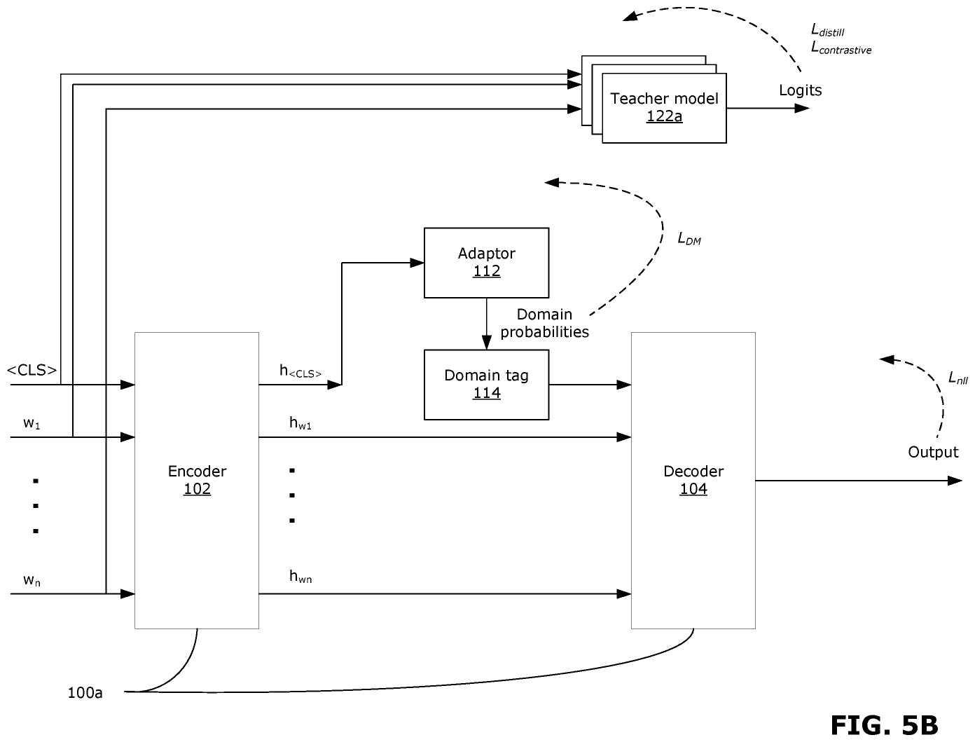

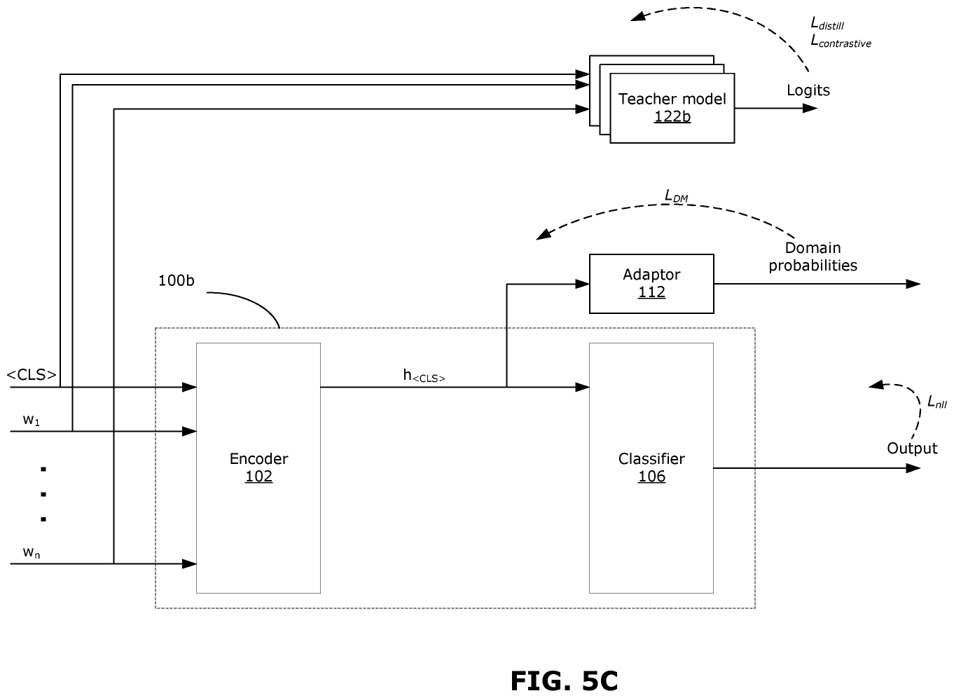

Multiple single-domain teacher models may be added to the previously-discussed architectures for training the neural network models 100a, 100b, to enable training using multi-teacher KD techniques together with using a domain mixing embedding vector. FIGS. 5A and 5B are block diagrams illustrating example architectures for training the neural network model 100a for a generative task, and FIG. 5C is a block diagram illustrating an example architecture for training the neural network model 100b for a discriminative task. FIGS. 5A and 5C illustrate examples in which the unique embedding vector h_{<CLS>} is used as a domain mixing embedding vector for input to the predictor (i.e., the decoder 104 or the classifier 106); FIG. 5B illustrate an examples in which the domain tag is used as a domain mixing embedding vector for input to the predictor. The domain tag may not be used as a domain mixing embedding vector for input to the classifier 106.

In the examples of FIGS. 5A-5C, multiple single-domain teacher models have been introduced. The neural network model 100a, 100b to be trained is considered to be the student model. For computing the distillation loss [symbol] _{distill}, the loss is computed between the logits generated by the in-domain teacher model and the logits generated by the neural network model 100a, 100b (more specifically, the logits generated by the predictor of the neural network model 100a, 100b (i.e., the decoder 104 or the classifier 106, respectively)).

FIGS. 5A and 5B are similar to FIGS. 1A and 3A, respectively, with the difference being the use of teacher models 122a. Features that are shared with FIGS. 1A and 3A have been labeled with the same reference numerals and need not be described again in detail. Likewise, FIG. 5C is similar to FIG. 1B, with the difference being the use of teacher models 122b. Features that are shared with FIG. 1B have been labeled with the same reference numerals and need not be described again in detail. It should be noted that in all examples, each teacher model 122a, 122b has the same architecture as the neural network model 100a, 100b, respectively, being trained. Thus, in the examples of FIGS. 5A and 5B where the neural network model 100a is trained for a generative task, each teacher model 122a has a neural network architecture that includes an encoder and a decoder; and in the example of FIG. 5C where the neural network model 100b is trained for a discriminative task, each teacher model 122b has a neural network architecture that includes an encoder and a classifier.

For simplicity and ease of understanding, the multiple single-domain teacher models 122a, 122b are shown collectively receiving, as input, the set of tokens (including the unique token) {<CLS> w₁, w₂, . . . , wₙ}, and generating, as output, logits. It should be understood that each teacher model 122a, 122b receives a respective instance of the set of tokens {<CLS> w₁, w₂, . . . , wₙ} as input and generates a respective set of logits as output.

In FIG. 5A, the unique embedding vector h_{<CLS>} (encoded from the unique token <CLS>, or other unique token) is provided as input to the decoder 104, together with the embedding vectors h_{w}_{₁}, . . . , h_{w}_{ₙ} (encoded from the tokenized data sample). In some examples, the unique embedding vector h_{<CLS>} is not necessarily included in the input to the decoder 104. Within each teacher model 122a, the unique token is similarly encoded into a unique embedding vector and is used as input to the decoder 104 of the respective teacher model 122a together with the embedding vectors encoded from the tokenized data sample. The logits generated by the in-domain teacher model 122a for a given data sample are used to compute the distillation loss [symbol] _{distill} (which is [symbol] _{KD} in the case where the loss used to learn the values of the parameters of the neural network model 100a to perform a generative task).

In FIG. 5B, the domain tag, computed using the domain probabilities and the domain embedding vectors from the adaptor network 112, is provided as input to the decoder 104, together with the embedding vectors h_{w}_{₁}, . . . , h_{w}_{ₙ} (encoded from the tokenized data sample). Within each teacher model 122a, a domain tag is similarly computed and used as input to the decoder 104 of the respective teacher model 122a together with the embedding vectors encoded from the tokenized data sample. The logits generated by the in-domain teacher model 122a for a given data sample are used to compute the distillation loss [symbol] _{distill} (which is [symbol] _{KD} in the case where the loss used to learn the values of the parameters of the neural network model 100a to perform a generative task).

In FIG. 5C, the unique embedding vector h_{<CLS>} (encoded from the unique token <CLS>, or other unique token) is provided as input to the classifier 106. Within each teacher model 122b, the unique token is similarly encoded into a unique embedding vector and is used as input to the classifier 106 of the respective teacher model 122b. The logits generated by the in-domain teacher model 122b for a given data sample are used to compute the distillation loss [symbol] _{distill} (which is [symbol] _{KL} in the case where the loss used to learn the values of the parameters of the neural network model 100b to perform a discriminative task).

In all of the examples of FIGS. 5A-5C, the computed distillation loss [symbol] _{distill} is included in computation of the final loss. The final loss [symbol] may thus be defined as:

[symbol]

=α [symbol] ₒᵤₜₚᵤₜ( [symbol] ,θ_{M})+β [symbol] _{distill}(θ_{T},θ_{M})+η [symbol] _{DM}

where α, β, and η are coefficients that control the contribution of each loss. The coefficients α, β, and η must sum to 1. The α, β, and η coefficients may be selected (e.g., empirically or using grid-search technique) to tune the convergence rate, for example. The output prediction loss [symbol] ₒᵤₜₚᵤₜ is defined as the nll loss [symbol] ₙₗₗ if the neural network model 100a is being trained to perform a generative task (i.e., the predictor is the decoder 104) and is defined as the BCE loss [symbol] _{BCE} the neural network model 100b is being trained to perform a discriminative task (i.e., the predictor is the classifier 106).

The above-described computation of the distillation loss [symbol] _{distill} is based on a conventional approach to KD for multi-domain training. Specifically, the training is based on only the contribution of the in-domain teacher model 122a, 122b for each iteration. In examples of the present disclosure, the conventional approach to multi-teacher KD is improved by also considering contributions from other teacher models 122a, 122b (i.e., out-of-domain teacher models) when computing the distillation loss [symbol] _{distill}. Such an approach may be useful, for example, in situations where there is overlap between different domains.

In particular, the domain probabilities outputted by the adaptor network 112 may be used to weight the logits of each teacher model 122a, 122b. A weighted aggregate set of logits may be defined as:

q^{j}=Σᵢ₌₁^{d}αᵢ·qᵢ^{j}

where q^{j} is the weighted aggregate set of logits computed for the j-th data sample, αᵢ is the domain probability for the i-th domain (where P is the softmax output of the adaptor network 112 and P=[α₁, α₂, . . . , α_{d}]), and qᵢ^{j} is the set of logits generated by the i-th teacher model 122a, 122b (i.e., the teacher model 122a, 122b trained for the i-th domain) for the j-th sample.

Using the domain probabilities to weight the logits from each teacher model, the distillation loss [symbol] _{distill} may be defined as follows for a generative task:

$${ℒ}_{distill} = {ℒ}_{KD} ( {θ}_{T} , {θ}_{M} ) = - \frac{1}{\vert 𝒟 \vert} {\sum }_{( x , y ) ∈ 𝒟} {\sum }_{i = 1}^{d} {α}_{i} \cdot {\sum }_{t = 1}^{{T}_{y}} {\sum }_{v = 1}^{\vert V \vert} q ( {y}_{t} = v \vert {y}_{< t} x ; {θ}_{T}^{i} ) log p ( {y}_{t} = v \vert {y}_{< t} x ; {θ}_{M} )$$

Similarly, using the domain probabilities to weight the logits from each teacher model, the distillation loss [symbol] _{distill} may be defined as follows for a discriminative task:

$${ℒ}_{distill} = {ℒ}_{KL} ( {θ}_{T} , {θ}_{M} ) = - \frac{1}{\vert 𝒟 \vert} {\sum }_{( x , y ) ε 𝒟} {\sum }_{i = 1}^{d} {α}_{i} \cdot q ( x , {θ}_{T}^{i} ) log ( \frac{q ( x , {θ}_{T}^{i} )}{q ( x , {θ}_{M} )} )$$

The distillation loss [symbol] _{distill} is then included in the computation of the final loss, as previously discussed.

The domain probabilities outputted by the adaptor network 112 indicates the probability of a given input data sample x to be from each domain. Conceptually, weighing the logits outputted by each teacher model 122a, 122b by the domain probabilities enables the contribution from each teacher model 122a, 122b to be adjusted according to the likelihood that the respective teacher model 122a, 122b is the relevant in-domain teacher model 122a, 122b for the given input data sample x. This approach enables training of the neural network model 100a, 100b to benefit from all teacher models across different domains, in each training iteration.

In some examples, contrastive learning may be used for multi-teacher KD training. Using the approach of contrastive learning, the neural network model 100a, 100b may be trained to be closer to the in-domain teacher model 122a, 122b and farther from the out-of-domain teacher models 122a, 122b. The logits generated by the in-domain teacher model 122a, 122b are considered to be the positive samples and the logits generated by the out-of-domain teacher models 122a, 122b are considered to be the negative samples. The contrastive loss (denoted as [symbol] _{contrastive}) may be defined as follows:

$${ℒ}_{contrastive} = - log \frac{exp ( \frac{sim ( {z}_{i} , {z}_{j} )}{τ} )}{{\sum }_{k = 1}^{𝒦} 1 \{ k \neq j \} exp ( \frac{sim ( {z}_{i} , {z}_{k} )}{τ} )}$$

where zᵢ denotes the logits generated by the student model (i.e., the neural network model 100a, 100b being trained), z₁ denotes the logits generated by the in-domain teacher model 122a, 122b, [symbol] denotes the total number of teacher models 122a, 122b, and τ denotes the temperature parameter (the temperature parameter is a normalization factor).

Conceptually, the goal of training using the contrastive loss [symbol] _{contrastive} is to increase the similarity between the logits generated by the in-domain teacher model 122a, 122b and the logits generated by the student model (i.e., the neural network model 100a, 100b).

The contrastive loss [symbol] _{contrastive} may be included in the computation of the final loss as follows:

[symbol]

=α [symbol] ₒᵤₜₚᵤₜ+ [symbol] _{contrastive}+η [symbol] _{DM}

where the contrastive loss [symbol] _{contrastive} replaces the distillation loss [symbol] _{distill}.

In some examples, the contrastive loss [symbol] _{contrastive} may be included in addition to the distillation loss [symbol] _{distill} in the final loss computation as follows:

[symbol]

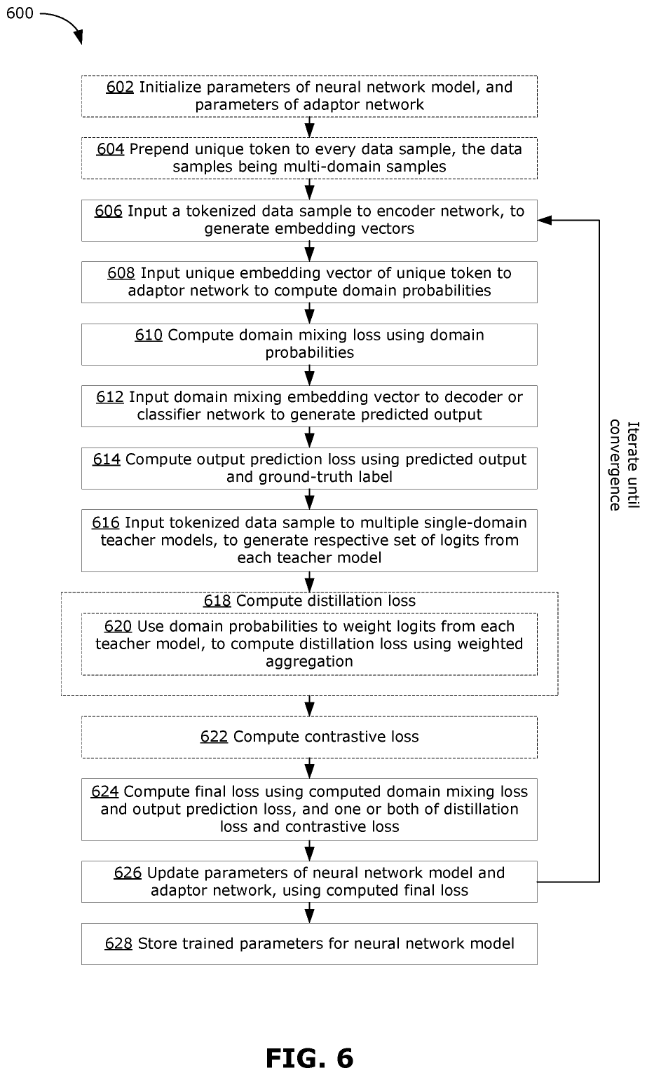

=α [symbol] ₒᵤₜₚᵤₜ+β(ν [symbol] _{contrastive}+δ [symbol] _{distill})+η [symbol] _{DM}

where ν+δ=1. FIG. 6 is a flowchart of an example method 600 for training a neural network model, where multi-teacher KD is used in addition to using an adaptor network to encode domain-related information. The method 600 may be used for training the neural network model 100a or the neural network model 100b, using the training architecture of FIG. 5A, 5B or 5C.

Various steps of the method 600 are similar to steps of the method 200 and the method 400 described previously, and will not be discussed in detail.

The method 600 includes steps 602 to 610, which are similar to steps 202 to 210 discussed above, and need not be repeated here in detail.

At 612, the domain mixing embedding vector is provided as input to the predictor (e.g., the decoder 104 or the classifier 106) of the neural network model 100a, 100b, to generate a predicted output. As previously discussed, the domain mixing embedding vector may be the unique embedding vector h_{<CLS>} that is encoded from the unique token (e.g., the <CLS> token or other unique token), or the domain mixing embedding vector may be the domain tag that is computed using the domain probabilities and domain embedding vectors generated by the adaptor network 112 (as previously noted, the domain tag may be used if the predictor is the decoder 104, and may not be used if the predictor is the classifier 106).

If the predictor is the decoder 104 (i.e., the neural network model 100a is being trained for a generative task), the domain mixing embedding vector is provided with the embedding vectors h_{w}_{₁}, . . . , h_{w}_{ₙ} encoded from the tokenized data sample. The predicted output generated by the decoder 104 is a set of predicted translated tokens.

If the predictor is the classifier 106 (i.e., the neural network model 100b is being trained for a discriminative task), input to the classifier 106 may be just the domain mixing embedding vector. The predicted output generated by the classifier 106 is a predicted class label.

At 614, the output prediction loss is computed, similar to step 214 described previously.

At 616, the tokenized data sample (including the unique token) is provided as input to each of a plurality of single-domain teacher models 122a, 122b. Each teacher model 122a, 122b generates a respective set of logits.

The logits generated by the teacher models 122a, 122b may be used to compute a distillation loss [symbol] _{distill}, a contrastive loss [symbol] _{contrastive}, or both.

Step 618 may be performed if a distillation loss [symbol] _{distill} is computed. The distillation loss [symbol] _{distill} may be computed between the logits generated by the neural network model 100a, 100b and the logits generated by the in-domain teacher model 122a, 122b. For example, the distillation loss [symbol] _{distill} may be computed using the equation for [symbol] _{KD} or [symbol] _{KL} discussed above (depending on whether the neural network 100a is being trained for a generative task, or if the neural network 100b is being trained for a discriminative task).

Optionally, step 620 may be performed as part of the computation of the distillation loss [symbol] _{distill}. At step 620, the distillation loss [symbol] _{distill} may be computed by using the domain probabilities (from the adaptor network 112) to weight the logits from each teacher model 122a, 122b, such that the distillation loss [symbol] _{distill} is computed using a weighted aggregation.

Step 622 may be performed if a contrastive loss [symbol] _{contrastive} is computed. For example, the contrastive loss [symbol] _{contrastive} may be computed using the equation described above.

At 624, a final loss is computed using the domain mixing loss [symbol] _{DM} and the output prediction loss [symbol] ₒᵤₜₚᵤₜ, as well as at least one of the distillation loss [symbol] _{distill} or the contrastive loss [symbol] _{contrastive}. The equation for computing the final loss L is described above, and need not be repeated here.

At 626, the values of the parameters θ_{M} of the neural network model 100a, 100b, as well as the values of the parameters (e.g., values in the weights matrix W) of the adaptor network 112 are updated using the computed final loss. For example, the gradients with respect to the final loss may be computed and the values of the parameters of the neural network model 100a, 100b and of the adaptor network 112 may be updated using a suitable optimization algorithm such as SGD.

All loss values are then reset and the method 600 may return to step 606 to process another data sample of the batch of data samples for another training iteration. The training iterations may repeat until a convergence condition is satisfied (e.g., a maximum number of iterations has been reached, or the loss values converge).

If the convergence condition is satisfied, then instead of returning to step 606 the method 600 proceeds to step 628 to store the learned values of the parameters θ_{M} of the neural network model 100a, 100b. The learned values of the parameters of the adaptor network 112 may also be stored (e.g., the learned values of the parameters of the adaptor network 112 may be stored in order to be used to compute the domain tag during inference), or may be discarded. During inference, the appropriate neural network model 100a, 100b is executed using the corresponding stored learned values of the parameters θ_{M}. The teacher models 122a, 122b are not used during inference.

In some examples, instead of using multiple single-domain teacher models 122a, 122b to train the neural network model 100a, 100b to perform a multi-domain task, a multi-domain teacher model may be used. In particular, the neural network model 100a, 100b that has been trained to perform a multi-domain task (e.g., using any of the previously described training architectures and methods) may be used as a multi-domain teacher model to train another instance of the same neural network model 100a, 100b (having the same architecture). This training technique may be referred to as self-distillation. In self-distillation, the teacher model and the student model have the same architecture, and the teacher model is a pre-trained version of the student model. The method for self-distillation involves first training the neural network model 100a, 100b using any of the above-discussed training architectures and techniques, then training the neural network model 100a, 100b again using the previously-trained version of the same neural network model 100a, 100b as a multi-domain teacher model. Self-distillation may be considered a regularization technique, and has been found to improve the performance of the trained neural network model 100a, 100b.

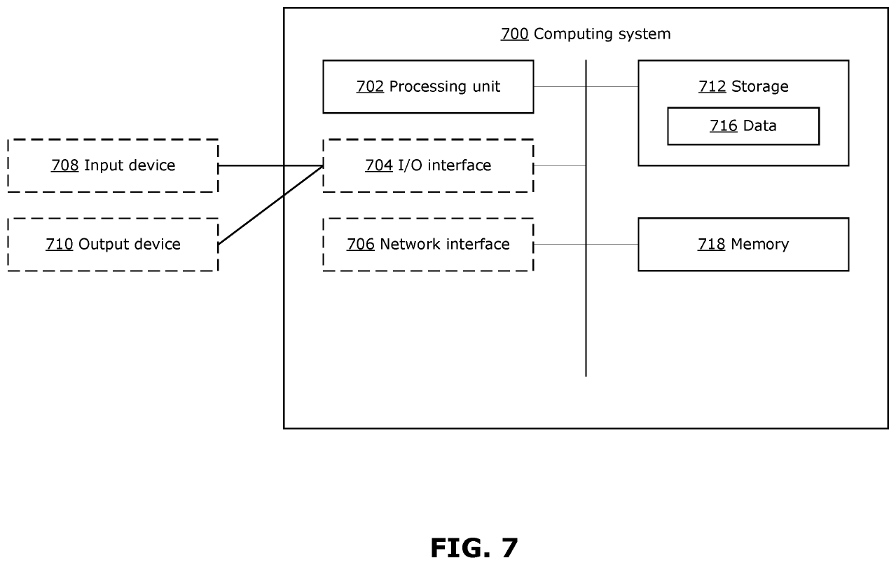

FIG. 7 is a block diagram illustrating a simplified example implementation of a computing system 700 suitable for implementing embodiments described herein. Examples of the present disclosure may be implemented in other computing systems, which may include components different from those discussed below. Although FIG. 7 shows a single instance of each component, there may be multiple instances of each component in the computing system 700. The computing system 700 may be used to execute instructions for training a neural network model, using any of the examples described above. The computing system 700 may also to execute the trained neural network model, or the trained neural network model may be executed by another computing system.

Although FIG. 7 shows a single instance of each component, there may be multiple instances of each component in the computing system 700. Further, although the computing system 700 is illustrated as a single block, the computing system 700 may be a single physical machine or device (e.g., implemented as a single computing device, such as a single workstation, single consumer device, single server, etc.), or may comprise a plurality of physical machines or devices (e.g., implemented as a server cluster). For example, the computing system 700 may represent a group of servers or cloud computing platform providing a virtualized pool of computing resources (e.g., a virtual machine, a virtual server).

The computing system 700 includes at least one processing unit 702, such as a processor, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof.

The computing system 700 may include an optional input/output (I/O) interface 704, which may enable interfacing with an optional input device 708 and/or optional output device 710.

In the example shown, the optional input device 708 (e.g., a keyboard, a mouse, a microphone, a touchscreen, and/or a keypad) and optional output device 710 (e.g., a display, a speaker and/or a printer) are shown as optional and external to the computing system 700. In other example embodiments, there may not be any input device 708 and output device 710, in which case the I/O interface 704 may not be needed.

The computing system 700 may include an optional network interface 706 for wired or wireless communication with other computing systems (e.g., other computing systems in a network). The network interface 706 may include wired links (e.g., Ethernet cable) and/or wireless links (e.g., one or more antennas) for intra-network and/or inter-network communications. For example, the network interface 706 may enable the computing system 700 to access data samples from an external database, or cloud-based data center (among other possibilities) where training datasets are stored. The network interface 706 may enable the computing system 700 to communicate trained parameters of a trained neural network model to another computing system (e.g., an edge computing device or other end consumer device) where the trained neural network model is to be deployed for inference.

The computing system 700 may include a storage unit 712, which may include a mass storage unit such as a solid state drive, a hard disk drive, a magnetic disk drive and/or an optical disk drive. The storage unit 712 may store data 716, such as the trained parameters of the trained neural network model.

The computing system 700 may include a memory 718, which may include a volatile or non-volatile memory (e.g., a flash memory, a random access memory (RAM), and/or a read-only memory (ROM)). The non-transitory memory 718 may store instructions for execution by the processing unit 702, such as to carry out example embodiments described in the present disclosure. For example, the memory 718 may store instructions for implementing any of the architectures and methods disclosed herein for training a neural network model. The memory 718 may include other software instructions, such as for implementing an operating system and other applications/functions.

The computing system 700 may additionally or alternatively execute instructions from an external memory (e.g., an external drive in wired or wireless communication with the server) or may be provided executable instructions by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

Examples of the present disclosure may be applicable to training a neural network to perform various tasks, including various generative or discriminative (e.g., classification) multi-domain tasks. In some examples, the present disclosure may be applicable to training a neural network to perform translation tasks, computer vision tasks, or sentiment analysis classification tasks, among other possibilities.

Although the preceding examples have been described in the context of NLP tasks, examples the present disclosure may also be implemented to train a neural network model to perform a multi-domain generative or discriminative computer vision task. The neural network model may be similar to the previously described neural network models (e.g., having an encoder that encodes the input data into a latent representation, and a predictor that generates a predicted output from the latent representation).

In the context of computer vision tasks, the input to the neural network model is an image rather than a tokenized text. A unique token does not need to be prepended to the input image. In the NLP context, the encoder encodes the unique token into a unique embedding vector, and the encoder is trained such that the unique embedding vector encodes domain-related information. In the computer vision context, the encoder encodes the input image into a representative vector (i.e., a latent vector representation of the features of the input image). This representative vector is inputted to the predictor (a decoder for a generative task, or a classifier for a discriminative task) to generate a predicted output. This representative vector is also inputted to the adaptor network, which generates domain probabilities. The domain probabilities are used to compute a domain mixing loss, as previously discussed, which is backpropagated to update the value of the parameters of the neural network model. The result is that the encoder is trained to encode domain-related information into the representative vector.

Thus, in the computer vision context, the representative vector that is encoded from the input image may also encode domain-related information. There is no need to use a unique token to enable encoding of domain-related information, unlike the examples described in the context of NLP tasks.

Multi-teacher KD may also be used to train the neural network model on NLP tasks. As previously described, domain probabilities generated by the adaptor network may be used to compute a distillation loss that is based on a weighted aggregation of logits from different single-domain teacher models (where the domain probabilities are used to weight the logits from corresponding single-domain teacher models). Self-distillation techniques may also be used to train the neural network model on NLP tasks.

Accordingly, one skilled in the art would understand that the present disclosure is not limited to training a neural network model on NLP tasks, and may be also adapted to train a neural network model on computer vision tasks, among other possibilities.

In various examples, the present disclosure has described different architectures and methods for training a neural network model to perform a multi-domain task. An adaptor network is used during training, which learns domain embedding vectors for each domain and generates domain probabilities. Output from the adaptor network is used to train the encoder in the neural network model to encode domain-related information. Domain-related information is also inputted to the predictor (e.g., decoder or classifier) in the neural network model.

The neural network model is trained to perform multi-domain task, which may be more practical to implement compared to using multiple models that are each trained to perform the same task in different single domains. This may be useful in scenarios where the trained neural network model is intended to be deployed in computing systems that have limited resources (e.g., limited computing power, limited memory resource, etc.). Training of the neural network model may be performed in a cloud-computing platform (e.g., as a training service accessible by client devices), or may be performed in a single computing device (e.g., at a client device), for example.

The present disclosure has described example generative tasks and discriminative tasks, and is applicable to training a neural network model for any generative or discriminative tasks, including NLP tasks such as parts-of-speech tagging or speech recognition, as well as computer vision tasks such as object recognition or image classification.

In some examples, the trained neural network model may be trained using multiple teacher models. This may help to mitigate against any adversarial attacks, since the trained neural network model is a result of knowledge distillation from multiple models.

Using examples disclosed herein, a single neural network model may be trained to dynamically learn from data samples in multiple domains. Further, as previously discussed, the techniques disclosed herein are not limited to multi-domain training, and may be used for multi-source training, multi-task training, multi-domain training, and combinations thereof. For multi-source training, the adaptor network may learn source embedding vectors and generate source probabilities; for multi-task training, the adaptor network may learn task embedding vectors and generate task probabilities.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a computing system to execute examples of the methods disclosed herein. The machine-executable instructions may be in the form of code sequences, configuration information, or other data, which, when executed, cause a machine (e.g., a processor or other processing unit) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method for training a neural network model having an encoder and a predictor, the method comprising:
inputting a set of tokens from a data sample to the encoder of the neural network model, the set of tokens including a unique token and other tokens, the encoder generating a set of embedding vectors including a unique embedding vector encoded from the unique token and other embedding vectors encoded from the other tokens;
inputting the unique embedding vector to an adaptor network to generate a set of domain probabilities representing a likelihood that the unique embedding vector belongs to each domain of a set of domains;
computing a domain mixing loss using the set of domain probabilities and a ground-truth domain of the data sample;
inputting at least a domain mixing embedding vector, determined from the unique embedding vector, to the predictor of the neural network model, to generate a predicted output;
computing an output prediction loss using the predicted output and a ground-truth label of the data sample;
computing a final loss using the domain mixing loss and the output prediction loss;
updating values of parameters of the neural network model and the adaptor network, using the computed final loss; and
storing the updated values of the parameters of the neural network model as learned values of the parameters of the neural network model.

2. The method of claim 1, wherein the predictor is a decoder, and wherein the other embedding vectors are also inputted to the decoder to generate the predicted output.

3. The method of claim 1, wherein the predictor is a classifier, and only the domain mixing embedding vector is inputted to the classifier to generate the predicted output.

4. The method of claim 1, wherein the domain mixing embedding vector is the unique embedding vector.

5. The method of claim 1, further comprising computing the domain mixing embedding vector by:
extracting, from the adaptor network, a domain embedding vector representing each respective domain in the set of domains; and
computing the domain mixing embedding vector as a weighted sum of the domain embedding vectors, each domain embedding vector being weighted by the respective domain probability for the respective domain.

6. The method of claim 1, further comprising:
inputting the set of tokens to each of a plurality of teacher models, to generate a respective set of logits from each teacher model, each teacher model being pre-trained in a respective single domain of the set of domains; and
computing at least one of a distillation loss or a contrastive loss using at least one set of logits from one teacher model and a set of logits generated by the predictor;
wherein the at least one of the distillation loss or the contrastive loss is further included in computing the final loss.

7. The method of claim 6, wherein the distillation loss is computed using the set of logits generated by the predictor and the set of logits generated by an in-domain teacher model, the in-domain teacher model being the teacher model that is pre-trained in the domain corresponding to the ground-truth domain of the data sample.

8. The method of claim 6, wherein the distillation loss is computed using the set of logits generated by the predictor and a weighted aggregation of the sets of logits from the plurality of teacher models, wherein each set of logit generated by a respective teacher model is weighted by the domain probability corresponding to the domain of the respective teacher model.

9. The method of claim 6, wherein both the distillation loss and the contrastive loss is computed, and both the distillation loss and the contrastive loss are further included in computing the final loss.

10. A computing system for training a neural network model having an encoder and a predictor, the computing system comprising a processing unit and a memory storing instructions which, when executed by the processing unit, cause the computing system to:
input a set of tokens from a data sample to the encoder of the neural network model, the set of tokens including a unique token and other tokens, the encoder generating a set of embedding vectors including a unique embedding vector encoded from the unique token and other embedding vectors encoded from the other tokens;
input the unique embedding vector to an adaptor network to generate a set of domain probabilities representing a likelihood that the unique embedding vector belongs to each domain of a set of domains;
compute a domain mixing loss using the set of domain probabilities and a ground-truth domain of the data sample;
input at least a domain mixing embedding vector, determined from the unique embedding vector, to the predictor of the neural network model, to generate a predicted output;
compute an output prediction loss using the predicted output and a ground-truth label of the data sample;
compute a final loss using the domain mixing loss and the output prediction loss;
update values of parameters of the neural network model and the adaptor network, using the computed final loss; and
store the updated values of the parameters of the neural network model as learned values of the parameters of the neural network model.

11. The computing system of claim 10, wherein the predictor is a decoder, and wherein the other embedding vectors are also inputted to the decoder to generate the predicted output.

12. The computing system of claim 10, wherein the predictor is a classifier, and only the domain mixing embedding vector is inputted to the classifier to generate the predicted output.

13. The computing system of claim 10, wherein the domain mixing embedding vector is the unique embedding vector.

14. The computing system of claim 10, wherein the instructions further cause the computing system to compute the domain mixing embedding vector by:
extracting, from the adaptor network, a domain embedding vector representing each respective domain in the set of domains; and
computing the domain mixing embedding vector as a weighted sum of the domain embedding vectors, each domain embedding vector being weighted by the respective domain probability for the respective domain.

15. The computing system of claim 10, wherein the instructions further cause the computing system to:
input the set of tokens to each of a plurality of teacher models, to generate a respective set of logits from each teacher model, each teacher model being pre-trained in a respective single domain of the set of domains; and
compute at least one of a distillation loss or a contrastive loss using at least one set of logits from one teacher model and a set of logits generated by the predictor;
wherein the at least one of the distillation loss or the contrastive loss is included in computing the final loss.

16. The computing system of claim 15, wherein the distillation loss is computed using the set of logits generated by the predictor and the set of logits generated by an in-domain teacher model, the in-domain teacher model being the teacher model that is pre-trained in the domain corresponding to the ground-truth domain of the data sample.

17. The computing system of claim 15, wherein the distillation loss is computed using the set of logits generated by the predictor and a weighted aggregation of the sets of logits from the plurality of teacher models, wherein each set of logit generated by a respective teacher model is weighted by the domain probability corresponding to the domain of the respective teacher model.

18. The computing system of claim 15, wherein both the distillation loss and the contrastive loss is computed, and both the distillation loss and the contrastive loss are further included in computing the final loss.

19. The computing system of claim 10, wherein the computing system provides a cloud-based service for training the neural network model.

20. A non-transitory computer readable medium having instructions encoded thereon, wherein the instructions, when executed by a processing unit of a computing system, cause the computing system to:
input a set of tokens from a data sample to an encoder of a neural network model, the set of tokens including a unique token and other tokens, the encoder generating a set of embedding vectors including a unique embedding vector encoded from the unique token and other embedding vectors encoded from the other tokens;
input the unique embedding vector to an adaptor network to generate a set of domain probabilities representing a likelihood that the unique embedding vector belongs to each domain of a set of domains;
compute a domain mixing loss using the set of domain probabilities and a ground-truth domain of the data sample;
input at least a domain mixing embedding vector, determined from the unique embedding vector, to a predictor of the neural network model, to generate a predicted output;
compute an output prediction loss using the predicted output and a ground-truth label of the data sample;
compute a final loss using the domain mixing loss and the output prediction loss;
update values of parameters of the neural network model and the adaptor network, using the computed final loss; and
store the updated values of the parameters of the neural network model as learned values of the parameters of the neural network model.
